(19) United States
(12) Patent Application Publication
(10) Pub. No.: US 2005/0156692 A1
(43) Pub. Date: Jul. 21, 2005

(54) Double density quasi-coax transmission lines

(76) Inventors: Lewis R. Dove, Monument, CO (US); John F. Casey, Colorado Springs, CO (US)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/761,972

(22) Filed: Jan. 20, 2004

(51) Int. Cl. H01P 3/06

(52) U.S. Cl. 333/243

(57) ABSTRACT

First and second mounds of dielectric respectively encapsulate first and second conductors. A third dielectric fills a valley between the first and second mounds of dielectric, and encapsulates a third conductor. A first ground shield is deposited on at least sides of the first and second mounds of dielectric, abutting the third dielectric. Second and third ground shields may run above and below the conductors. In this manner, first, second and third transmission lines are formed.

### CROSS-REFERENCE TO RELATED APPLICATIONS

This application is related to the application of John F. Casey, et al. entitled “Methods for Making Microwave Circuits” Ser. No. ______ (Docket No. 10020707-1), the application of John F. Casey, et al. entitled “Methods for Forming a Conductor on a Dielectric” Ser. No. ______ (Docket No. 10030748-1), and the application of John F. Casey, et al. entitled “Methods for Depositing a Thickfilm Dielectric on a Substrate” Ser. No. ______ (Docket No. 10030747-1). These applications are hereby incorporated by reference for all that they disclose.

### BACKGROUND

The patent application of Casey et al. entitled “Methods for Making Microwave Circuits”, cross-referenced supra, discloses methods for making microwave circuits in which conductors are encapsulated in generally trapezoidal mounds of dielectric. As disclosed by Casey et al., a microwave circuit may be formed by depositing a first dielectric over a ground plane, and then forming a conductor on the first dielectric. A second dielectric is then deposited over the conductor and first dielectric, thereby encapsulating the conductor between the first and second dielectrics. Finally, a ground shield layer is formed over the first and second dielectrics.

### SUMMARY OF THE INVENTION

One aspect of the invention is embodied in apparatus comprising first and second mounds of dielectric that respectively encapsulate first and second conductors. A third dielectric fills a valley between the first and second mounds of dielectric, and encapsulates a third conductor. A ground shield is deposited on at least sides of the first and second mounds of dielectric, abutting the third dielectric.

Another aspect of the invention is embodied in a first method for forming shielded transmission lines. The method comprises depositing first and second lower mounds of dielectric on a first ground shield. First and second conductors are then deposited on the first and second lower mounds, and first and second upper mounds of dielectric are deposited on the first and second lower mounds of dielectric. Thereafter, a second ground shield is deposited over the first and second dielectrics. A third lower dielectric is deposited in a valley between the first and second dielectrics, and a third conductor is deposited thereon. A third upper dielectric is then deposited on the third lower dielectric, and a third ground shield is deposited over the third upper dielectric.

Yet another aspect of the invention is embodied in a second method for forming shielded transmission lines. The method comprises depositing first and second lower mounds of dielectric on a first ground shield. Ground shield walls are then deposited on sides of the first and second lower mounds, and a third lower dielectric is deposited in a valley between the first and second lower mounds of dielectric. Thereafter, conductors are deposited on each of the lower dielectrics, and first and second upper mounds of dielectric are then deposited on the first and second lower mounds of dielectric. Next, ground shield caps are deposited over the first and second upper mounds of dielectric, and a third upper dielectric is deposited on the third lower dielectric. Finally, a second ground shield is deposited over the third upper dielectric.

Other embodiments of the invention are also disclosed.

### BRIEF DESCRIPTION OF THE DRAWINGS

Illustrative embodiments of the invention are illustrated in the drawings, in which:

FIG. 1 illustrates a first plurality of quasi-coax transmission lines;

FIG. 2 illustrates a second plurality of quasi-coax transmission lines, capable of being formed at twice the density of the quasi-coax transmission lines shown in FIG. 1;

FIG. 3 illustrates a cross-section of the transmission lines shown in FIG. 2;

FIG. 4 illustrates a first exemplary method for forming quasi-coax transmission lines;

FIGS. 5 & 6 illustrate the formation of quasi-coax transmission lines at various stages of the FIG. 4 method;

FIG. 7 illustrates a second exemplary method for forming quasi-coax transmission lines; and

FIGS. 8 & 9 illustrate the formation of quasi-coax transmission lines at various stages of the FIG. 7 method.

### DETAILED DESCRIPTION OF THE INVENTION

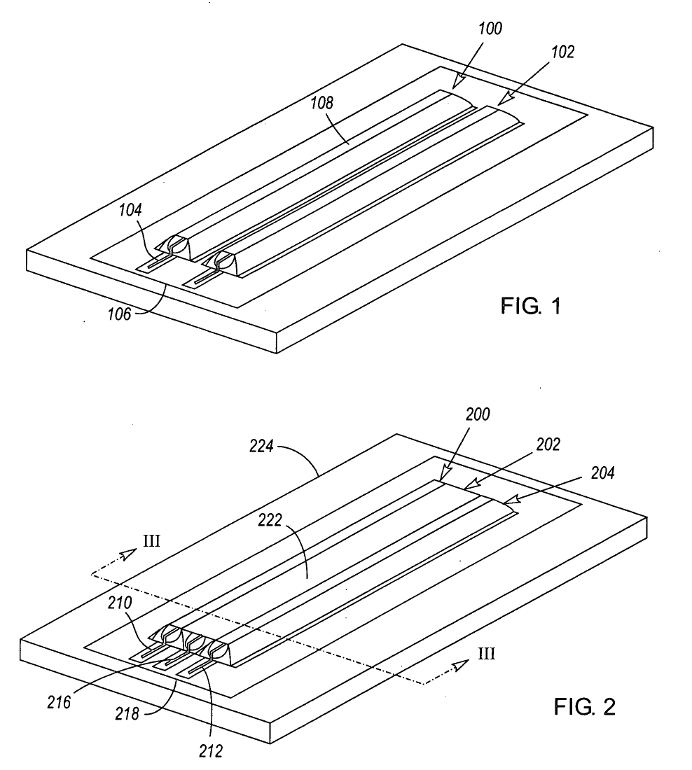

FIG. 1 illustrates a plurality of quasi-coax transmission lines 100, 102 formed in accordance with the teachings of Casey, et al.'s patent application entitled “Methods for Making Microwave Circuits”, cross-referenced supra. As defined herein, a quasi-coax transmission line 100 comprises a conductor 104, the cross-section of which is shielded 106, 108 in a non-symmetrical fashion.

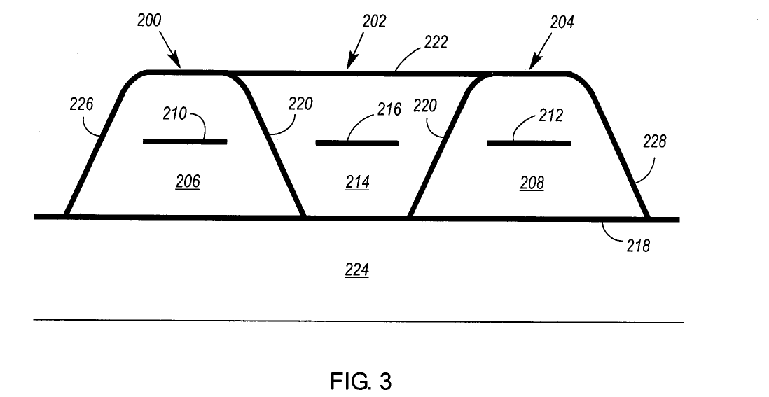

FIGS. 2 & 3 illustrate a plurality of quasi-coax transmission lines 200, 202, 204 formed in accordance with the methods disclosed herein. FIG. 2 illustrates the transmission lines 200-204 in perspective; and FIG. 3 illustrates the transmission lines 200-204 in cross-section.

Referring to FIG. 3, it can be seen that first and second mounds of dielectric 206, 208 respectively encapsulate first and second conductors 210, 212. A third dielectric 214 fills a valley between the first and second mounds of dielectric 206, 208, and encapsulates a third conductor 216.

The conductors 210, 212, 216 are shielded by first, second and third ground shields 218, 220, 222. The first ground shield 218 may be deposited on (or may form) a substrate 224 on which the first and second mounds of dielectric 206, 208 are deposited. The second ground shield 220 is deposited on sides of the first and second mounds of dielectric 206, 208, abutting the third dielectric 214.

In one embodiment of the FIG. 3 transmission lines 200-204, the ground shield covering the tops and exterior walls 224, 226 of the first and second mounds of dielectric 206, 208 is the second ground shield 220. In another embodiment, the ground shield covering the exterior walls 224, 226 of the first and second mounds of dielectric 206, 208 is the third ground shield 222, and the ground shield covering the tops of the first and second mounds of dielectric 206, 208 is the third ground shield 222. In other embodiments, the tops and exterior walls 224, 226 of the first and second mounds of dielectric 206, 208 may be shielded by other means.

Preferably, the first, second and third ground shields 218-222 contact one another so as to encapsulate at least some cross-sections of the first and second mounds of dielectric 206, 208 (e.g., as shown in the cross-section illustrated in FIG. 3). However, in some cross-sections of the transmission lines 200-204, the ground shields 218-222 may not contact one another. For example, breaks in the ground shields 218-222 may be necessary to aid in routing input and output signals to/from the conductors 210, 212, 216, or to aid in attaching other transmission line structures and/or circuit components to the transmission lines 200-204.

By way of example, the dielectrics 206, 208, 214 shown in FIGS. 2 & 3 may be glass or ceramic dielectrics. In one embodiment, the dielectrics are KQ CL-90-7858 dielectrics (thickfilm glass dielectrics) available from Heraeus Cermalloy (24 Union Hill Road, West Conshohocken, Pa., USA). The substrate 224 may be a 40 mil lapped alumina ceramic substrate with a gold ground shield 218 deposited thereon. Alternatively, the substrate 224 may have a glass, ceramic, polymer, metallic or other composition. If metallic, the substrate 224 itself may serve as the ground shield 218. The conductors 210, 212, 216 and ground shields 218-222 may be deposited by printing a thickfilm conductive paste, such as DuPont® QG150, through an appropriate stencil or screen.

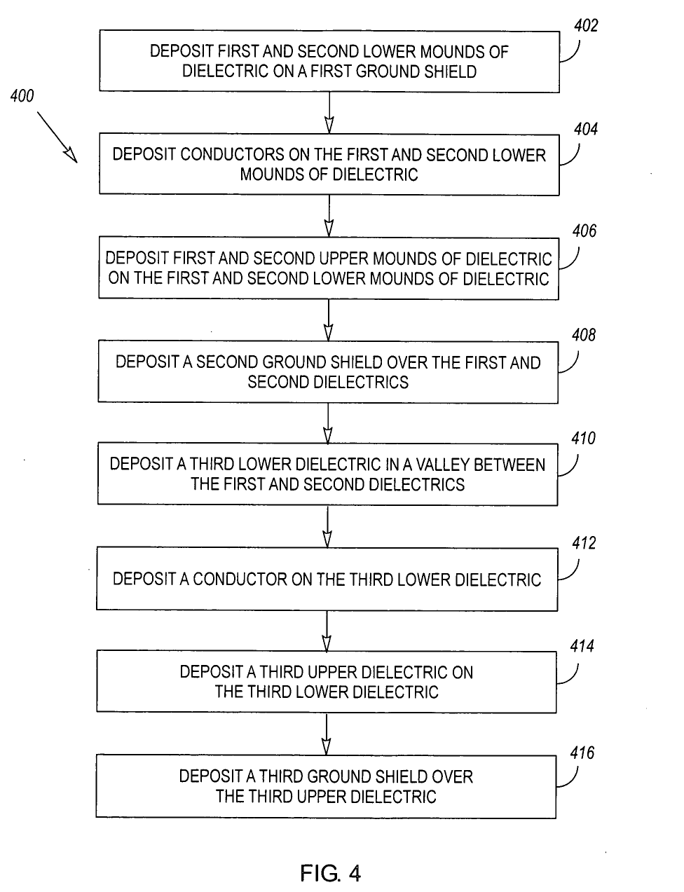

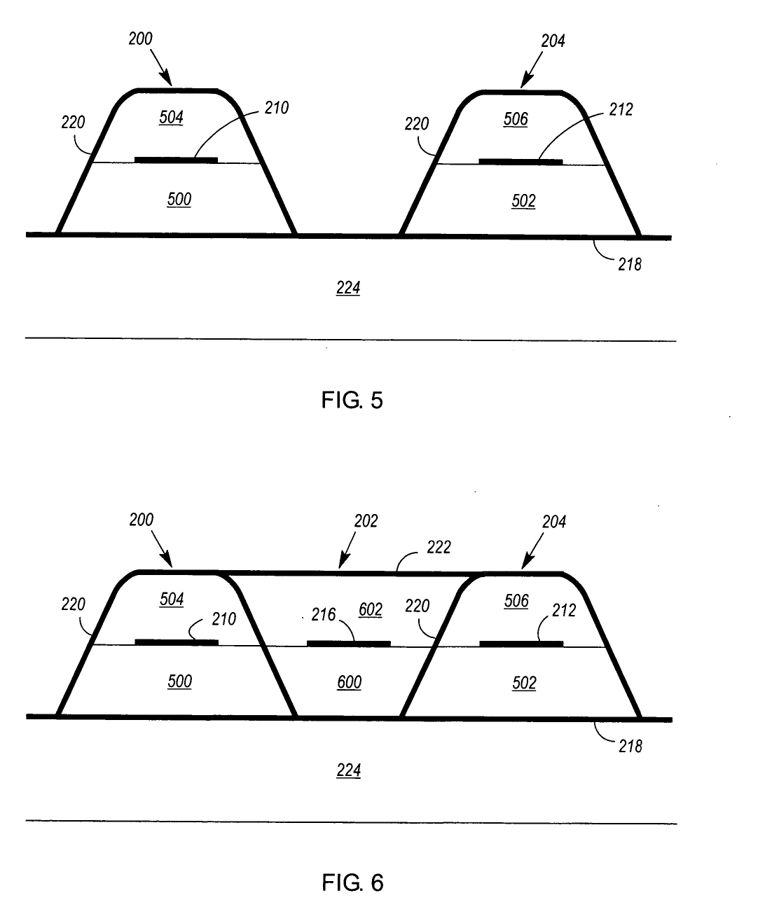

FIG. 4 illustrates a first method 400 for forming the shielded transmission lines 200-204 shown in FIGS. 2 & 3. To begin, first and second lower mounds of dielectric 500, 502 are deposited 402 on a first ground shield 218, as shown in FIG. 5. Conductors 210, 212 are then deposited 404 on each of the first and second lower mounds 500, 502, and first and second upper mounds of dielectric 504, 506 are deposited 406 on the first and second lower mounds of dielectric 500, 502. Thereafter, a second ground shield 220 is deposited 408 over the first and second dielectrics 500-506. Referring to FIG. 6, a third lower dielectric 600 is deposited 410 in a valley between the first and second dielectrics 500-506, and a conductor 216 is deposited 412 thereon. A third upper dielectric 602 is then deposited 414 on the third lower dielectric 508, and a third ground shield 222 is deposited 416 over the third upper dielectric 602.

The mounds of dielectric 500-506, 600, 602 may be deposited, for example, by using a thickfilm printing process. Some exemplary thickfilm printing processes are disclosed in the patent application of Casey et al. entitled “Methods for Making Microwave Circuits”. In accordance with Casey et al.'s methods, each of the dielectrics 500-506, 600, 602 may be deposited by printing multiple layers of thickfilm dielectric and then firing the layers. If desired, the upper and/or lower dielectrics 500-506, 600, 602 may be ground and polished to adjust their thickness. It may also be desirable to polish the lower dielectrics 500, 502, 600 to provide smoother surfaces for deposition of the conductors 210, 212, 216.

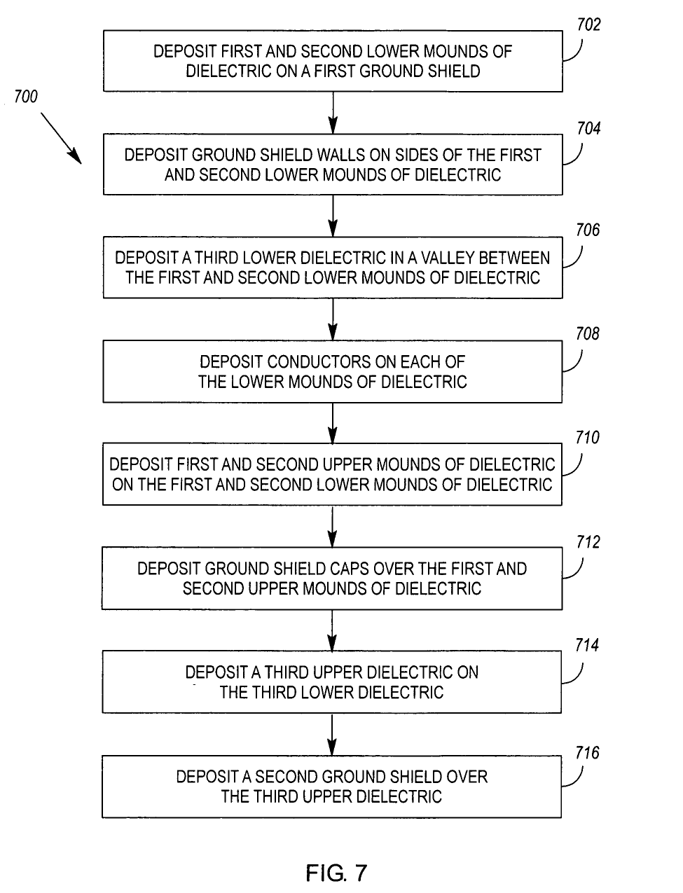

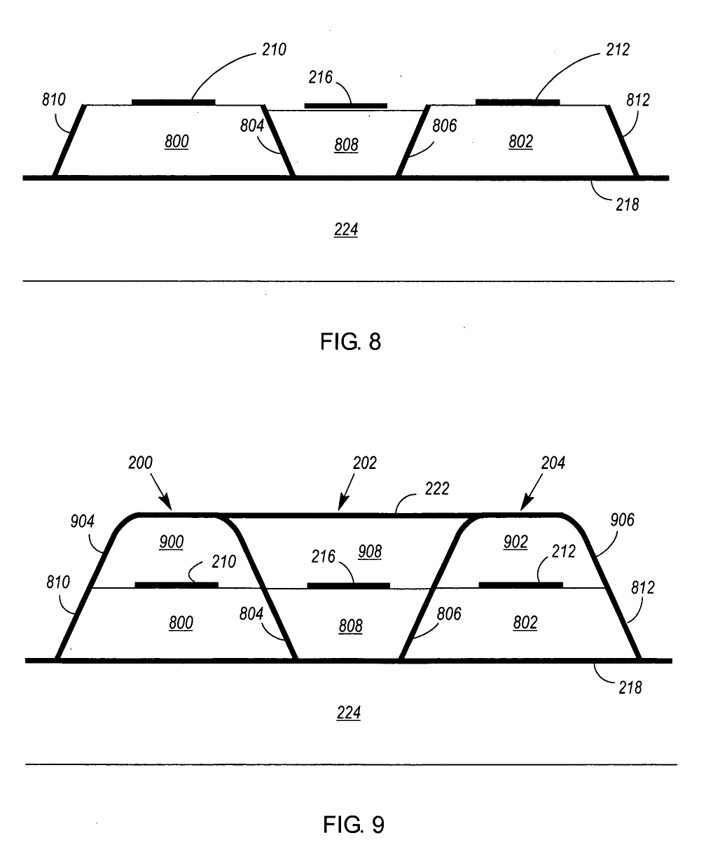

FIG. 7 illustrates a second method 700 for forming the shielded transmission lines 200-204 shown in FIGS. 2 & 3. To begin, first and second lower mounds of dielectric 800, 802 are deposited 702 on a first ground shield 218, as shown in FIG. 8. Ground shield walls 804, 806, 810, 812 are then deposited 704 on sides of the first and second lower mounds 800, 802. Thereafter, a third lower dielectric 808 is deposited 706 in a valley between the first and second lower mounds of dielectric 800, 802, and conductors 210, 212, 216 are deposited 708 on each of the lower dielectrics 800, 802, 808. Referring to FIG. 9, following deposition of the conductors 210, 212, 216, first and second upper mounds of dielectric 900, 902 are deposited 710 on the first and second lower mounds of dielectric 800, 802. Ground shield caps 904, 906 are then deposited 712 over the first and second upper mounds of dielectric 900, 902. Thereafter, a third upper dielectric 908 is deposited 714 on the third lower dielectric 808, and a second ground shield 222 is deposited 716 over the third upper dielectric 908.

The method 700 shown in FIG. 7 is advantageous over the method 400 shown in FIG. 4 in that formation of the third transmission line 202 begins at a time when heights of the first and second dielectrics 800, 802 are smaller, thus enabling a screen, stencil, or the like to be placed in closer proximity to the bottom surface of the valley between the first and second dielectrics 800, 802, thereby enabling the more precise deposition of a layer of dielectric 808 in the valley.

In one embodiment of the FIG. 7 method, the third lower dielectric 808 (FIG. 8) is printed slightly thinner than the first and second lower mounds of dielectric 800, 802. In this manner, the ground shield caps 904, 906 are more likely to make good contact with the ground shield walls 806, 810.

The methods and apparatus disclosed herein are advantageous, in one respect, in that they enable the formation of quasi-coax transmission lines at twice the density that was previous possible.

As will be understood by one of ordinary skill in the art, the three transmission lines 200-204 shown in FIGS. 2 & 3 are illustrative only, and any number of adjacent transmission lines could be formed in a similar fashion.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

1. Apparatus, comprising:
a) first and second mounds of dielectric, respectively encapsulating first and second conductors;
b) a third dielectric, filling a valley between the first and second mounds of dielectric, and encapsulating a third conductor; and
c) a first ground shield deposited on at least sides of the first and second mounds of dielectric, abutting the third dielectric.

2. The apparatus of claim 1, further comprising a second ground shield on which the first and second mounds of dielectric are deposited; wherein the first ground shield extends to the second ground shield.

3. The apparatus of claim 2, further comprising a third ground shield deposited on the third dielectric; the third ground shield contacting the first ground shield.

4. The apparatus of claim 1, wherein the dielectrics are glass dielectrics.

5. The apparatus of claim 1, wherein the dielectrics are KQ dielectrics.

6. The apparatus of claim 5, wherein the KQ dielectrics are KQ CL-90-7858 dielectrics.

7. The apparatus of claim 1, wherein the dielectrics are thickfilm dielectrics.

8. A method for forming shielded transmission lines, comprising:
a) depositing first and second lower mounds of dielectric on a first ground shield;
b) depositing conductors on the first and second lower mounds of dielectric;
c) depositing first and second upper mounds of dielectric on the first and second lower mounds of dielectric;
d) depositing a second ground shield over the first and second dielectrics;
e) depositing a third lower dielectric in a valley between the first and second dielectrics;
f) depositing a conductor on the third lower dielectric;
g) depositing a third upper dielectric on the third lower dielectric; and
h) depositing a third ground shield over the third upper dielectric.

9. The method of claim 8, wherein the dielectrics are glass dielectrics.

10. The method of claim 8, wherein the dielectrics are KQ dielectrics.

11. The method of claim 10, wherein the KQ dielectrics are KQ CL-90-7858 dielectrics.

12. The method of claim 8, wherein the dielectrics are thickfilm dielectrics.

13. A method for forming shielded transmission lines, comprising:
a) depositing first and second lower mounds of dielectric on a first ground shield;
b) depositing ground shield walls on sides of the first and second lower mounds of dielectric;
c) depositing a third lower dielectric in a valley between the first and second lower mounds of dielectric;
d) depositing conductors on each of the lower mounds of dielectric;
e) depositing first and second upper mounds of dielectric on the first and second lower mounds of dielectric;
f) depositing ground shield caps over the first and second upper mounds of dielectric;
g) depositing a third upper dielectric on the third lower dielectric; and
h) depositing a second ground shield over the third upper dielectric.

14. The method of claim 13, wherein the dielectrics are glass dielectrics.

15. The method of claim 13, wherein the dielectrics are KQ dielectrics.

16. The method of claim 15, wherein the KQ dielectrics are KQ CL-90-7858 dielectrics.

17. The method of claim 13, further comprising polishing the lower dielectrics prior to depositing the conductors.

18. The method of claim 13, wherein each of the dielectrics is deposited by printing multiple layers of thickfilm dielectric and then firing the layers.

19. The method of claim 18, further comprising polishing the lower dielectrics prior to depositing the conductors.

20. The method of claim 13, wherein the height of the third lower dielectric is less than the heights of the first and second lower mounds of dielectric.
